(19) United States
(12) Patent Application Publication
(10) Pub. No.: US 2025/0025375 A1
(43) Pub. Date: Jan. 23, 2025

(54) SAUNA HEATER

(71) Applicant: DCC TECHNOLOGY CO., LTD., Taichung City (TW)

(72) Inventor: Ching-Song Chen, Taichung City (TW)

(21) Appl. No.: 18/353,961

(22) Filed: Jul. 18, 2023

(51) Int. Cl. A61H 33/06

(52) U.S. Cl. CPC A61H 33/063; A61H 2201/0242; A61H 2201/5043; A61H 2201/5097

(57) ABSTRACT

A heater for sauna includes a housing including top, bottom, front, rear board, left, and right boards; the top, bottom, left, and the right boards each having spaced slot members; and the bottom board having two holes; a heating device including heating elements having four sides fastened in the slot members respectively, each heating element including heating, first insulator, and second insulator layers, and two conductive strips in which the heating layer is secured onto the first insulator layer; the first insulator layer protects the heating layer; the conductive strips are secured onto two sides of the heating layer respectively; and the second insulator layer is secured onto the heating layer; and a convection device including two fans in the holes respectively and directly under the heating elements. The front board has a display panel and an on/off switch.

### FIELD OF THE INVENTION

The invention relates to heaters and more particularly to a sauna heater having improved characteristics.

### BACKGROUND OF THE INVENTION

A conventional centralized heater is shown in FIGS. 7 to 9 and comprises a housing 1, a plurality of parallel, plate-shaped heating elements 2 in the housing 1, and a temperature controller 3 electrically connected to the heating elements 2 for controlling temperature of the heater. The heating element 2 includes a rectangular heating layer 4, two elongated conductive copper foils 5 at two sides of the heating layer 4 respectively, and top and bottom insulator layers 6 enclosed the heating layer 4 and the copper foils 5 using heat and pressure. The heating elements 2 have advantages of effectively transferring heat in forms of radiation and convection, preventing the hands of a user from being hurt, and increased safety in use.

However, the heating elements 2 are prone to carbonize, resulting in a decrease of useful like because the heating layers 4 are made of graphite and the insulator layers 6 are made of glass fiber.

Thus, the need for improvement still exists.

### SUMMARY OF THE INVENTION

It is therefore one object of the invention to provide a sauna heater comprising a housing including a top board, a bottom board, a front board, a rear board, a left board, and a right board wherein the top board, the bottom board, the left board, and the right board each have a plurality of spaced slot members, and the bottom board has two holes; a heating device including a plurality of plate-shaped heating elements having four sides fastened in the slot members of the top board, the bottom, the left board, and the right board respectively so that the heating elements are equally spaced in the housing, wherein each of the heating elements include a heating layer, a first insulator layer, two parallel conductive strips, and a second insulator layer; wherein the heating layer is secured onto the first insulator layer for electricity conduction and heat transfer; wherein the first insulator layer is configured to protect the heating layer and transfer heat so that the heating layer is configured to uniformly transfer heat; wherein the conductive strips are secured onto two sides of the heating layer respectively and configured to conduct electricity; and wherein the second insulator layer is secured onto the heating layer for achieving thermal insulation; and a convection device including two fans on an underside of the heating elements wherein the fans are disposed in the holes of the bottom board respectively; and wherein the fans are vertically aligned with the heating elements.

The invention has the following advantages and benefits in comparison with the conventional art: the heating layer of each heating element is implemented as a graphene coating and graphene is electrically conductive and has a high thermal conductivity. The heating layer is secured onto the first insulator layer which is made of crystalline glass. The heating elements are not prone to carbonize. Further, the heating elements are provided in the housing and the housing is made of wood. Thus, a bather may not be hurt when touching the housing. This increases safety when bathing in the sauna. The fans are provided on the underside of the heating elements. In response to energizing the heating elements, the heating layer of each heating element heats to emit infrared radiation through the first insulator layer and the second insulator layer respectively. Further, the fans draw air externally of the sauna heater through gaps between the heating elements. And in turn, temperature in the sauna increases quickly. The heating elements have increased thermal conductivity. A bather may feel a degree of comfort because the temperature in the sauna is kept at an appropriate range. The sauna is warm and not dry. This is in contrast to the conventional sauna which is excessively hot due to poor heat transfer and the bather may be hurt when touching a heat source or a component installed therein.

The above and other objects, features and advantages of the invention will become apparent from the following detailed description taken with the accompanying drawings

### BRIEF DESCRIPTION OF THE DRAWINGS

FIG. 1 is a perspective view of a sauna heater according to a preferred embodiment of the invention;

FIG. 2 is another perspective view of the sauna heater;

FIG. 3 is an exploded view of the sauna heater;

FIG. 4 is an exploded view of the heating element;

FIG. 5 is a longitudinal sectional view of the sauna heater;

FIG. 6 schematically depicts airflow paths of the sauna heater in operation;

FIG. 7 is a perspective view of a conventional centralized heater;

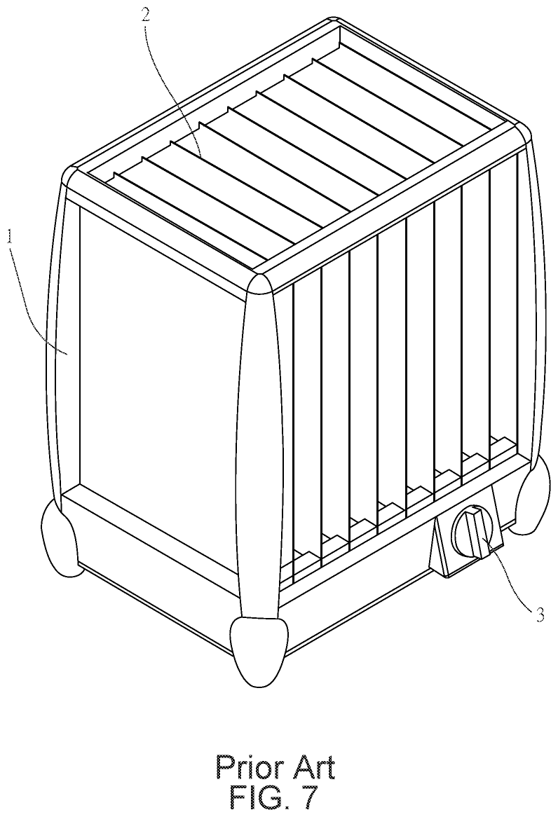

FIG. 8 is a perspective view of the heating element in FIG. 7; and

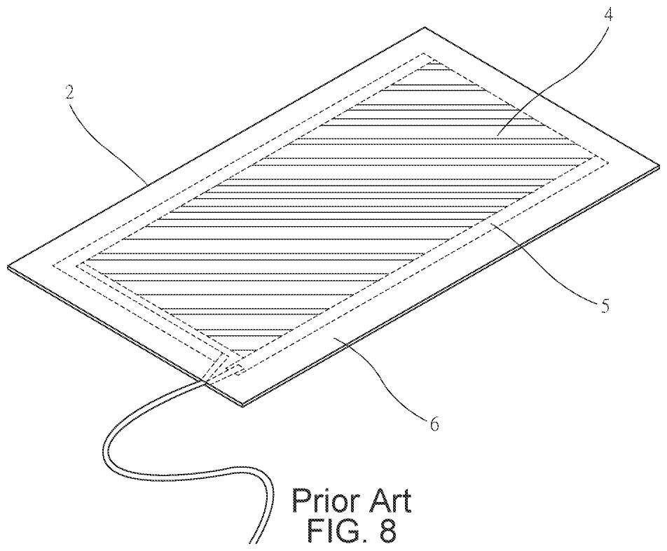

FIG. 9 is an exploded view of the heating element in FIG. 8.

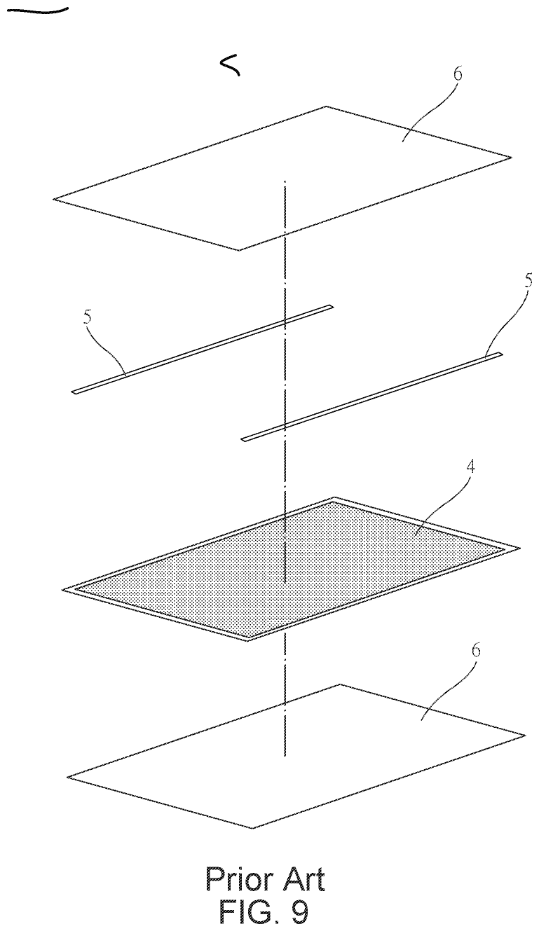

### DETAILED DESCRIPTION OF THE INVENTION

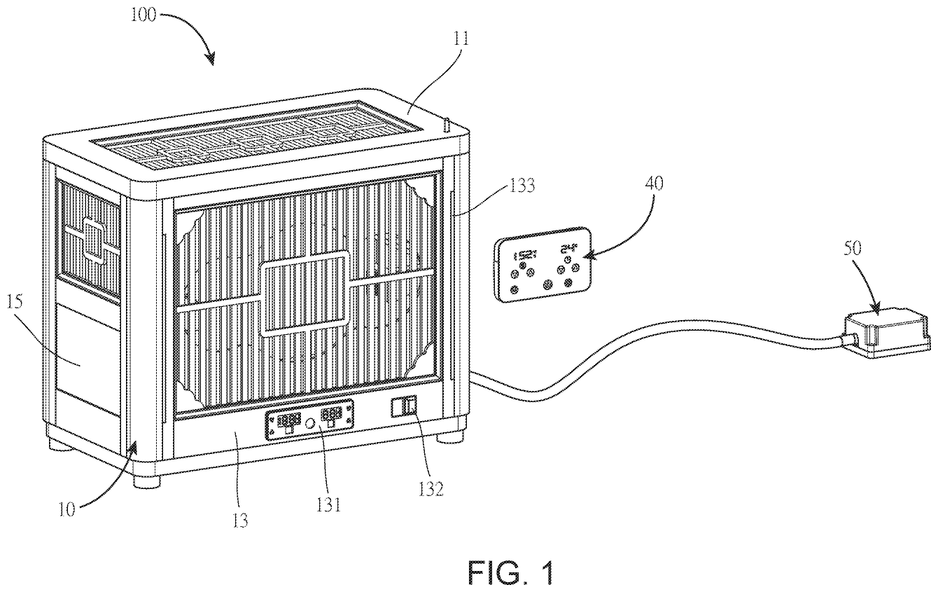

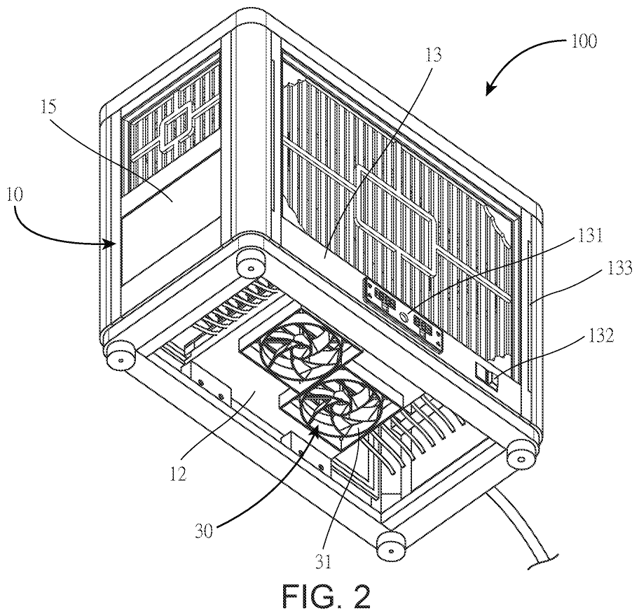

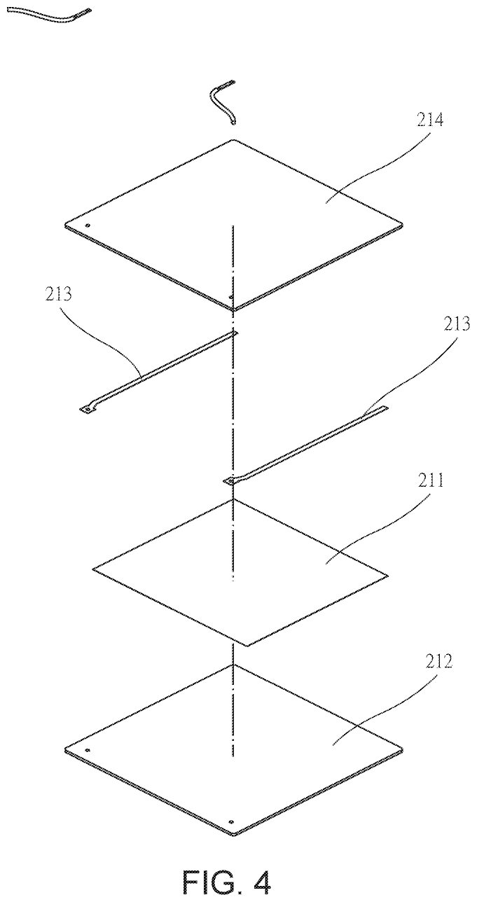

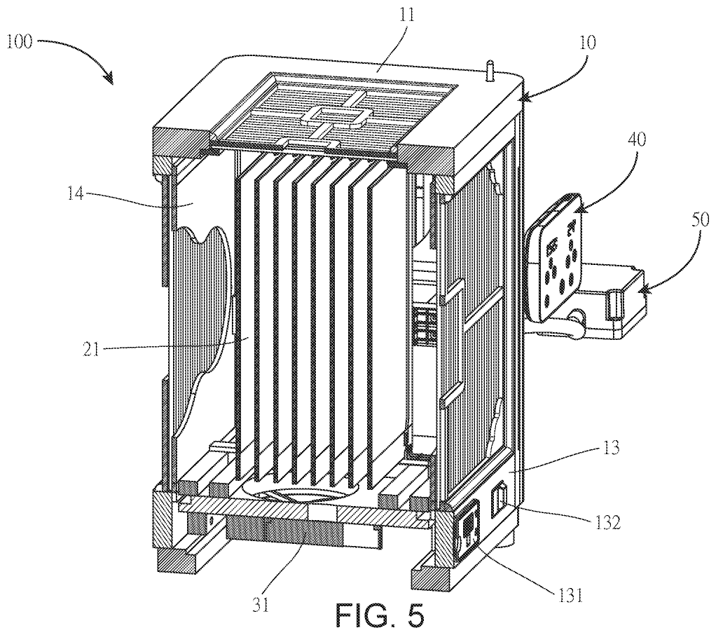

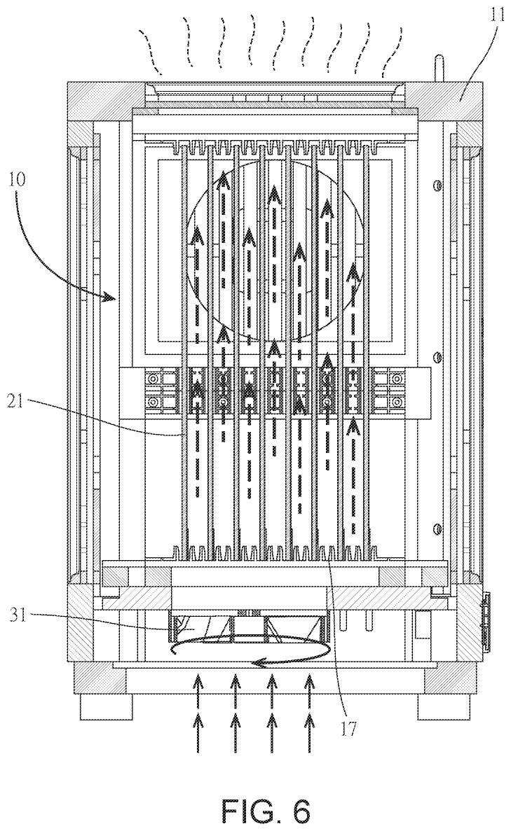

Referring to FIGS. 1 to 6, a sauna heater 100 in accordance with a preferred embodiment of the invention comprises the following components as discussed in detail below.

A housing 10 is made of wood and includes a top board 11, a bottom board 12, a front board 13, a rear board 14, a left board 15, and a right board 16. The top board 11, the bottom board 12, the left board 15 and the right board 16 each have a plurality of spaced slot members 17. The bottom board 12 has two holes 121. The front board 13 has a display panel 131 and an on/off switch 132 both on a lower portion. Temperature and time are shown on the display panel 131. A user can press the on/off switch 132 to activate or deactivate the sauna heater 100. Two light bars 133 are provided on two sides of the front board 13 respectively.

A heating device 20 includes a plurality of rectangular plate-shaped heating elements 21 having four sides fastened in the slot members 17 of the top board 11, the bottom 12, the left board 15, and the right board 16 respectively. Thus, the heating elements 21 are equally spaced in the housing 10. The heating element 21 includes a heating layer 211, a first insulator layer 212, two parallel conductive strips 213, and a second insulator layer 214. The heating layer 211 is implemented as a graphene coating and graphene is electrically conductive, has a high thermal conductivity, and is capable of emitting infrared radiation. The heating layer 211 is secured onto the first insulator layer 212. The first insulator layer 212 is made of crystalline glass (e.g., silicon crystal glass) and configured to protect the heating layer 211 and transfer heat. Thus, the heating layer 211 may uniformly transfer heat. The conductive strips 213 are secured onto two sides of the heating layer 211 respectively and configured to conduct electricity. The conductive strips 213 are made of plasma. The second insulator layer 214 is secured onto the heating layer 211 for achieving thermal insulation. The second insulator layer 214 is implemented as a coating having excellent thermal insulation. Bottoms of the heating elements 21 are electrically connected to a power supply 50 which is also electrically connected to the display panel 131.

A convection device 30 includes two fans 31 on an underside of the heating elements 21. The fans 31 are disposed in the holes 121 of the bottom board 12 respectively. The fans 31 are vertically aligned with the heating elements 21.

A remote control 40 is electrically connected to the display panel 131. A user may operate the remote control 40 to set desired temperature and time of the sauna heater 100 so that the sauna heater 100 can heat to operate at the temperature. The desired temperature and time of the sauna heater 100 are shown on the display panel 131.

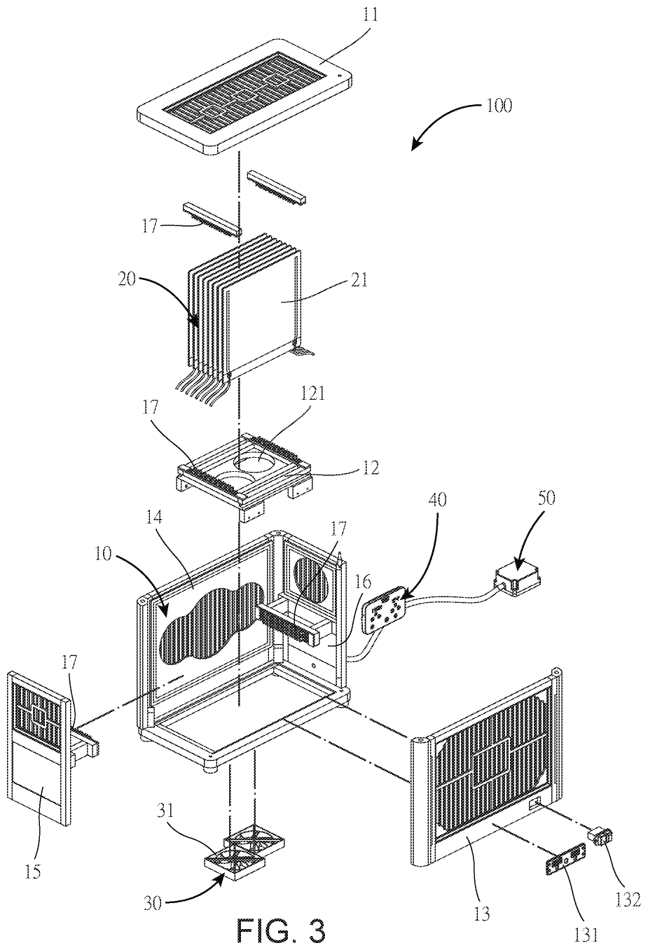

As shown in FIGS. 3 to 6 specifically, the sauna heater 100 is disposed in a sauna (e.g., dry steam room). A user may press the on/off switch 132 prior to use. Thus, the sauna heater 100 is activated. Next, the user may operate the remote control 40 to set desired temperature and time of the sauna heater 100. Preferably, the temperature is set at 50-60° C. and the time is set at 10 minutes in the embodiment of the invention. In response to energizing the heating elements 21, the heating layer 211 of each heating element 211 heats to emit infrared radiation through the first insulator layer 212 and the second insulator layer 214 respectively. Further, the fans 31 draw air externally of the sauna heater 100 through gaps between the heating elements 21. And in turn, the heating elements 21 heat the air prior to exiting the top board 11 of the housing 10. As a result, the sauna is heated. The steam and high heat make the bathers perspire, thereby accelerating metabolism, eliminating fatigue and discomfort, and increasing vitality.

The invention has the following advantages and benefits in comparison with the conventional art: the provision of the plurality of the heating elements 21 increases a total heating area. The heating layer 211 of each heating element 21 is implemented as a graphene coating and graphene is electrically conductive and has a high thermal conductivity. The heating layer 211 is secured onto the first insulator layer 212 which is made of crystalline glass. The heating elements 21 are not prone to carbonize. Further, the heating elements 21 are provided in the housing 10 and the housing 10 is made of wood. Thus, a bather may not be hurt when touching the housing 10. This increases safety when bathing in the sauna. The fans 31 are provided on the underside of the heating elements 21. In response to energizing the heating elements 21, the heating layer 211 of each heating element 21 heats to emit infrared radiation through the first insulator layer 212 and the second insulator layer 214 respectively. Further, the fans 31 draw air externally of the sauna heater 100 through gaps between the heating elements 21. And in turn, temperature in the sauna increases quickly. The heating elements 21 have increased thermal conductivity. A bather may feel a degree of comfort because the temperature in the sauna is kept at an appropriate range. The sauna is warm and not dry. This is in contrast to the conventional sauna which is excessively hot due to poor heat transfer and the bather may be hurt when touching a heat source or a component installed therein.

While the invention has been described in terms of preferred embodiments, those skilled in the art will recognize that the invention can be practiced with modifications within the spirit and scope of the appended claims.

What is claimed is:

1. A sauna heater, comprising:
a housing including a top board, a bottom board, a front board, a rear board, a left board, and a right board wherein the top board, the bottom board, the left board, and the right board each have a plurality of spaced slot members, and the bottom board has two holes;
a heating device including a plurality of plate-shaped heating elements having four sides fastened in the slot members of the top board, the bottom, the left board, and the right board respectively so that the heating elements are equally spaced in the housing, wherein each of the heating elements include a heating layer, a first insulator layer, two parallel conductive strips, and a second insulator layer; wherein the heating layer is secured onto the first insulator layer for electricity conduction and heat transfer; wherein the first insulator layer is configured to protect the heating layer and transfer heat so that the heating layer is configured to uniformly transfer heat; wherein the conductive strips are secured onto two sides of the heating layer respectively and configured to conduct electricity; and wherein the second insulator layer is secured onto the heating layer for achieving thermal insulation; and
a convection device including two fans on an underside of the heating elements wherein the fans are disposed in the holes of the bottom board respectively; and wherein the fans are vertically aligned with the heating elements.

2. The sauna heater of claim 1, wherein the front board has a display panel and an on/off switch, wherein the display panel is configured to show temperature and time, and wherein the on/off switch is configured to activate or deactivate the sauna heater, further comprising two light bars disposed on two sides of the front board respectively.

3. The sauna heater of claim 2, wherein bottoms of the heating elements are electrically connected to a power supply which is electrically connected to the display panel.

4. The sauna heater of claim 2, further comprising a remote control electrically connected to the display panel.

5. The sauna heater of claim 1, wherein the heating layer is implemented as a graphene coating and the conductive strips are made of plasma.

6. The sauna heater of claim 1, wherein the first insulator layer is made of crystalline glass and the second insulator layer is implemented as a coating having excellent thermal insulation.

7. The sauna heater of claim 1, wherein the housing is made of wood.
